(19) United States
(12) Patent Application Publication
(10) Pub. No.: US 2020/0106089 A1
(43) Pub. Date: Apr. 2, 2020

(54) Lithium Ion Accumulator And Material And Process For Production Thereof

(71) Applicant: Siemens Aktiengesellschaft, Munchen (DE)

(72) Inventors: Christian Doye, Berlin (DE); Jens Dahl Jensen, Berlin (DE); Ursus Krüger, Berlin (DE); Gabriele Winkler, Berlin (DE)

(73) Assignee: Siemens Aktiengesellschaft, Munchen (DE)

(21) Appl. No.: 16/580,753

(22) Filed: Sep. 24, 2019

(30) Foreign Application Priority Data
Sep. 27, 2018 (EP) 18197255.5

(51) Int. Cl. H01M 4/131; H01M 10/0525; H01M 4/66; H01M 4/80; H01M 4/133

(52) U.S. Cl. CPC H01M 4/131; H01M 10/0525; H01M 4/133; H01M 4/80; H01M 4/663

(57) ABSTRACT

Various embodiments include a material for a lithium ion accumulator comprising: a surface including electrically conductive particles coated with a functional layer providing a cathodic or anodic function for the lithium ion accumulator. The conductive particles comprise microparticles and/or nanoparticles.

### CROSS-REFERENCE TO RELATED APPLICATIONS

This application claims priority to EP Patent Application No. 18197255.5, filed on Sep. 27, 2018. The contents of the aforesaid application are incorporated herein for all purposes.

### TECHNICAL FIELD

The present disclosure relates to energy storage. Various embodiments may include materials for a lithium ion accumulator (also referred to hereinafter as accumulator for short), lithium ion accumulators comprising such a material, and/or processes for producing a lithium ion accumulator.

### BACKGROUND

Lithium ion accumulators are used in modern portable electronic devices (mobile phones, tablets, notebooks), and in modern vehicle technology (cars, aircraft), and also in aerospace technology. Compared to other types of battery, lithium ion batteries have a high energy density, high power density, and high nominal voltage, as well as a higher number of possible charging cycles before the accumulator loses performance and capacity. For operation of cars and aircraft, a further increase in energy density would be desirable in order firstly to reduce the weight of the accumulators and secondly to extend the range of the modes of transport mentioned.

For the anode material in particular, ground materials are nowadays used, for example graphite, germanium, silicon, boron, tungsten, and/or tungsten carbide ground in a high-energy ball mill under protective gas at 1000 to 1500 RPM (revolutions per minute). This gives rise to alloys of germanium-carbon-boron, silicon-carbon-boron, germanium-carbon-boron-tungsten, germanium-silicon-carbon-boron or germanium-carbon-tungsten. After grinding, the particles have a size of 20 to 100 nm. The alloys are processed together with a conductive agent (graphite, graphene, carbon nanotubes) in a binder (polyvinylidene fluoride, PVDF) and then applied to a current collector.

The cathode material can be synthesized via a relatively low-cost sol-gel method. For this purpose, stoichiometric solution volumes of lithium citrate C₆H₅LiO₇ with water, manganese(II) acetate (CH₃COO)₂Mn with water and nickel(II) acetate (CH₃COO)₂Ni with water are mixed with vigorous stirring. After thorough mixing, the precursor solution is dried in a microwave until a transparent gel is formed. After grinding, the gel is transferred to a tubular oven and heated to 350° C. for two hours. The resultant product is mixed with ethanol and then dried in a ball mill for 6 hours. Subsequently, the resulting solution is dried in a spray drier. The air feed temperature is 180° C. and the air exit temperature 90° C. Subsequently, the spray-dried powder is sintered at 750° C. in the surrounding atmosphere for 10 hours.

The result is an Ni-doped lithium manganese oxide powder (LiMn₂O₄). In order to improve the electrical performance of the Li ion battery, the mesoporous LiNiMn₂O₄ powder particles can be coated with NiCo₂O₄. For this purpose, nickel nitrate and cobalt(I) nitrate are dissolved in deionized water to form a homogeneous solution. Then the LiNiMn₂O₄ powder is added to the metal nitrate solution and stirred under ultrasound for three hours to obtain a homogeneous suspension. Subsequently, a nonstoichiometric solution volume of acetic acid is added gradually to the suspension with vigorous stirring and aged at room temperature for 30 minutes. After filtering, washing, drying, and heat treatment at 250° C. in the surrounding atmosphere, what is obtained is NiCo₂O₂-coated LiNiMn₂O₄ powder. For preparation of a cathode, the active powder material is mixed thoroughly with acetylene black and polyvinylidene fluoride (PVDF) and dissolved in N-methyl-pyrrolidone to obtain a homogeneous slurry. The slurry formed is applied to an aluminum foil by brush plating and dried in a vacuum oven at 120° C. for 12 hours to form a cathode.

### SUMMARY

The teachings of the present disclosure describe a material for a lithium ion accumulator that enables a high power density on discharge with a simultaneously low weight (low power to weight ratio), a lithium ion accumulator, and a process for producing such a lithium ion accumulator, wherein the accumulator produced has the abovementioned properties. For example, some embodiments include a material for a lithium ion accumulator (70) characterized in that it has, at least at its surface, electrically conductive microparticles or nanoparticles coated with at least one functional layer for creation of the cathodic or anodic function of the lithium ion accumulator (70).

In some embodiments, the microparticles or nanoparticles consist of graphite, titania with an electrically conductive coating, carbon nanotubes or graphene nanoplatelets.

In some embodiments, the microparticles or nanoparticles take the form of needles, flakes or platelets.

In some embodiments, the at least one functional layer has a thickness of less than 500 nm, e.g. the thickness of one layer of atoms.

In some embodiments, the microparticles or nanoparticles are intended for the anode of the lithium ion accumulator (70), where these have multiple layers in the following sequence from the inside outward, consisting of: germanium (50), boron or boron oxide (51), and lithium (52).

In some embodiments, the microparticles or nanoparticles are intended for the cathode of a lithium ion accumulator (70), where said cathode consists of a lithium metal oxide or lithium metal phosphate.

In some embodiments, the anode has been formed from a material (71) as claimed in claim 5 as anode material and the cathode from a material (71) as claimed in claim 6 as cathode material.

In some embodiments, the anode material and the cathode material are mixed in a matrix consisting of a plastic, especially polyvinylidene fluoride, PVDF for short, or acrylonitrile-butadiene-styrene, ABS for short.

In some embodiments, electrically conductive particles (74), especially titania needles with an electrically conductive coating or carbon nanotubes, have additionally been incorporated in the matrix (72).

In some embodiments, the anode material (71a) and the cathode material (71b) form separate layers separated from one another by an interlayer that serves as electrolyte.

In some embodiments, particles (74), especially titania needles with an electrically conductive coating or carbon nanotubes, have been incorporated in the anode material (71a) and/or in the cathode material (71b).

As another example, some embodiments include a process for producing a lithium ion accumulator (70), characterized in that the anode is produced from a material (71) as described above as anode material (71a) and the cathode from a material (71) as described above as cathode material (71b).

In some embodiments, the anode material (71a) and/or the cathode material (71b) are introduced in mixed form into a matrix (72) consisting of a plastic, especially polyvinylidene fluoride, PVDF for short, or acrylonitrile-butadiene-styrene, ABS for short.

In some embodiments, the anode material (71a) and/or the cathode material (71b) is processed by means of an additive manufacturing method, especially fused filament fabrication, FFF for short.

In some embodiments, the process is conducted in a fluidized bed reactor.

### BRIEF DESCRIPTION OF THE DRAWINGS

The figures show:

FIG. 1 and FIG. 2: working examples of fluidized bed reactors (FBR for short) for use process taught herein, in schematic section;

FIG. 3 to FIG. 6: working examples of precursors for production of germanium on the anodic particles, each as structural formulae;

FIG. 7 to FIG. 9: working examples of precursors for production of boron oxide on the anodic particles, each as structural formulae;

FIG. 10 and FIG. 11: working examples for precursors for production of lithium on the anodic particles, each as structural formulae;

FIG. 12 and FIG. 13: working examples of the needles of the invention coated with anode material, each in schematic section;

FIG. 14 to FIG. 24: working examples of precursors for production of iron on the cathodic particles, each as structural formulae;

FIG. 25 and FIG. 26: working examples of precursors for production of silicon iron phosphate, each as structural formulae;

FIG. 27: a working example of a cathodic nanoparticle in the form of a titanium needle, coated, in schematic section;

FIG. 28 to FIG. 32: working examples of precursors for production of lithium manganese phosphate, each as structural formulae;

FIG. 33 and FIG. 34: working examples of lithium ion accumulators incorporating teachings of the present disclosure, in schematic section.

### DETAILED DESCRIPTION

In some embodiments, a material has, at least at its surface, electrically conductive microparticles or nanoparticles coated with at least one functional layer for creation of the cathodic or anodic function of the lithium ion accumulator. To enhance the energy density, the surface areas of the energy-storing materials may be increased. An increase in surface area can firstly be achieved via the configuration of the electrodes in terms of shape and structure, and of the carrier of the electrochemically active material, and secondly via the decrease in size of the active material particles involved in the formation of the electrodes to the nanoscale to atomic range. The miniaturization can be achieved by atomic layer deposition of the energy-storing materials on a nanoscale carrier substance.

Electrical conductivity of the microparticles or nanoparticles at least on their surface can be achieved in that the particles (i.e. microparticles or nanoparticles) that are nonconductive per se are provided with an electrically conductive coating. Alternatively, it is of course also possible that the material of the microparticles or nanoparticles (referred to hereinafter collectively simply as particles) is itself electrically conductive, which obviates the need for any additional coating with an electrically conductive material.

In some embodiments, at least one functional layer on the surface of the particles accounts for either the cathodic or anodic function of the lithium ion accumulator. These particles are thus suitable for further processing to produce an accumulator. The use of the particles enables a compact construction of the accumulator, and for that reason it is of low weight relative to its capacity. At the same time, the power density to be drawn can be chosen at a comparatively high level (more on that hereinafter). An accumulator which is produced from the material described above thus achieves the objects stated above.

In some embodiments, the microparticles or nanoparticles consist of graphite, titania with an electrically conductive coating, carbon nanotubes, and/or graphene nanoplatelets. For production of the material, they subsequently have to be coated with the functional layer. Thus, inexpensive production of the material is possible, and this can subsequently be modified to form accumulators having the required profile of requirements (low power to weight ratio, high power density on discharge). In some embodiments, the microparticles or nanoparticles take the form of needles, flakes or platelets.

When the microparticles are in the form of needles or in the form of flakes or platelets, the surface area thereof is comparatively large compared to their mass. The surface area is in turn available for coating with the cathodic or anodic functional layer. As a result, it is possible to accommodate a comparatively large amount of the functional material on the surface of the particles. As a result, it is especially possible to increase the power density on discharge, since the current can be released over a larger area.

In some embodiments, at least one functional layer has a thickness of less than 500 nm, e.g., the thickness of one layer of atoms. The thinner the functional layer, the better the utility of the material in relation to the mass of it used. This likewise has an effect on the power density and total weight of the accumulator. In some embodiments, the material utilizes tunneling effects in the discharge of the accumulator, which further increases the power density of the current that can be drawn. Deposition of individual layers of atoms on the particles can be accomplished using an ALD method (more on that later).

In some embodiments, the microparticles or nanoparticles are intended for the anode of the lithium ion accumulator, where these have multiple layers in the following sequence from the inside outward, consisting of:
germanium,
boron or boron oxide, and/or
lithium.

The anode material may be produced in the manner specified. This is done by depositing germanium, the electrically conductive carrier material, for example on the electrically insulating titania needles. This is followed by deposition of boron or boron oxide and then lithium from the vapor phase, it being possible to use different metal precursors (ALD method, more on that later).

This gives rise to very thin layers having high efficiency in relation to the mass of the material used.

In some embodiments, the microparticles or nanoparticles are intended for the cathode of a lithium ion accumulator, where said cathode consists of a lithium metal oxide or lithium metal phosphate. In the case of lithium ion-based accumulators, a lithium metal oxide or lithium metal phosphate is typically required as cathode material. This material can likewise be deposited on the particles to form the anode material. The thin layers on the particles, owing to the high surface area, enable rapid progression of the chemical processes, which brings a high possible energy density on discharge.

In some embodiments, the anode is formed from the material of this disclosure as anode material and the cathode from the material of this disclosure as cathode material. By virtue of the material that has been described in detail above being employed as anode material and as cathode material, it is possible to provide a lithium ion accumulator which, with simultaneously high capacity and power density on discharge, is of comparatively low weight. The accumulators described herein are therefore especially suitable as drive battery, for example for land vehicles, watercraft and aircraft. Especially in aviation, a high power to weight ratio of the energy carrier is of major importance.

In some embodiments, the anode material and the cathode material are mixed in a matrix consisting of a plastic, especially polyvinylidene fluoride, PVDF for short, or acrylonitrile-butadiene-styrene, ABS for short. By virtue of the material (i.e. the anode material and the cathode material) being introduced into the matrix, the result may be a particularly stable accumulator assembly. It is also possible for the plastic to simultaneously constitute the electrolyte required for the function of the accumulator. This electrolyte may be particularly safe in operation since no liquids can escape in the case of the accumulator of the invention (since the electrolyte is solid).

In some embodiments, electrically conductive particles, especially titania needles with an electrically conductive coating or carbon nanotubes, have additionally been incorporated in the matrix. The introduction of additional conductive particles has the advantage that battery currents (charging and discharging) can flow more quickly. As a result, the current density achievable via the construction principle of anode and cathode can also be removed reliably from the accumulator. It is not necessary here to rely exclusively on the tunneling effects that take place in the coatings on the particles; instead, the electrical current is guided directly across the conductive particles.

In order to produce an electrically conductive, coherent network in the accumulator, the electrically conductive particles may be introduced into the material in a concentration above the percolation threshold. The percolation threshold is defined in that the adjacent electrically conductive particles in the accumulator come into contact sufficiently frequently for the electrical current to be guided through the entire accumulator across these particles. Therefore, the attainment of the percolation threshold is also defined in that the electrical conductivity of a material (the accumulator here) rises abruptly.

In some embodiments, the anode material and the cathode material form separate layers separated from one another by an interlayer that serves as electrolyte. By comparison with the above-elucidated accumulator having a plastic matrix, the construction here is one in which the interlayer assumes the function of the electrolyte. This construction may be easy to produce. Moreover, the amount of electrolyte required can be influenced in a simple manner by the choice of thickness of the interlayer.

In some embodiments, particles, e.g. titania needles with an electrically conductive coating or carbon nanotubes, have been incorporated in the anode material and/or in the cathode material. By these processes then, it is possible to produce a lithium ion accumulator with the materials described herein. The process may be suitable for implementing the required profile of properties (high power density, low power to weight ratio) in an accumulator.

In some embodiments, the anode material and/or the cathode material are introduced in mixed form into a matrix consisting of a plastic, especially polyvinylidene fluoride, PVDF for short, or acrylonitrile-butadiene-styrene, ABS for short. In this configuration, it is thus possible to achieve a construction of the accumulator in the form already described. In this form, the anode material and the cathode material are mixed in a matrix of plastic that simultaneously constitute the electrolyte.

In some embodiments, the anode material and/or the cathode material is processed by means of an additive manufacturing method, e.g. fused filament fabrication, FFF for short. FFF enables production of three-dimensional battery structures which may be executed, for example, as a lining of housings. In this way, a particularly space-saving arrangement of the accumulators thus produced is possible. Moreover, it is possible by the process to achieve good and homogeneous mixing ratios of the plastic processed because the particles can be mixed directly into the filaments processed.

In some embodiments, the process is conducted in a fluidized bed reactor. The process of coating in a fluidized bed reactor is what is called an ALD method. The materials can be deposited directly from the gas phase from precursors, by means of which it is even possible to deposit monolayers of atoms on the particles. In this way, high-precision coating operations are possible, and it is possible to utilize tunneling effects for conduction of electrical current and maintenance of the battery functions. This enables particularly high current densities and a low power to weight ratio of the accumulators produced.

The use of needles, platelets or flakes in the nano- or microscale range increases the surface area of the active material and allows it to assume three-dimensional structures. Electrically conductive titania needles, in the event of mechanical and thermal damage to the lithium cells, are safer than graphite or graphene since titania does not begin to melt until 1865° C. and graphite ignites in the presence of oxygen at 600° C. The use of titania avoids self-ignition and explosion of the cell. Titania needles have the advantage that, owing to the geometric form, less material is required for incorporation into binders or polymer materials (polyvinylidene fluoride, PVDF) than with spherical particles since these particles of anisotropic dimensions can form a conductive network.

On account of its physical and chemical procedure, the ALD method promotes very thin, homogeneous and concordant coatings having the desired stoichiometry and microstructure. In the ALD method, the surface reactions are self-limiting by virtue of the nature of the process regime, such that the active materials are deposited in a calculable and reproducible manner in terms of layer thickness and composition. It is possible to exactly adjust the amount of charge, the energy content, the battery capacity and the energy density.

Layer thicknesses in the atomic range and nanometer range enable tunneling effects and hopping mechanisms for the conduction of electrons. The electrons can jump more quickly from a localized state to an adjacent state, since the distances between the layers and particles are short. By virtue of the atomic layer deposition, the energy-storing and electrochemically active materials can be joined seamlessly to one another, such that there is barely any internal resistance between the materials and charge (electrons and ions) can be transported without barriers.

The coated needles or coated carbon particles (graphite, graphene nanoplatelets and CNTs) can be used for production of 3D batteries via incorporation into plastic filaments (polyvinylidene fluoride PVDF or acrylonitrile-butadiene-styrene ABS) in the FFF (fused filament fabrication) printing method. It is thus possible to considerably improve the energy density and power density of printed lithium ion accumulators. Thus, when these coated, conductive carrier materials are used in 3D printing, the electrode surface area is increased in three ways: 1. change in shape of the electrode from 2D to 3D by processing of a 3D CAD data format, 2. process-related infill structure of the volume bodies in the FFF printing method (the electrode surface area is increased once again internally), 3. coating of electrically conductive carrier materials of anisotropic dimensions via ALD methods.

Production of short-circuit-resistant, noncombustible, nonexplosive cells that are not prone to thermal runaway (overheating) is possible. The geometric form of particles (for example needles, flakes, platelets) gives a better ratio of surface area to volume than spherical particles. This fact helps in the mixing, for example, into polymeric materials. The surface area is increased without needing to wet excessively small particles. Only ⅓ to ½ of the mass is required compared to spherical particles.

Production of high-energy cells by the use of the carrier particles of anisotropic dimensions because more energy-storing material can be deposited on the increased particle surface areas. Production of high-energy cells by the use of ALD because the energy-storing and electrochemically active materials can be deposited in atomic layer thickness. The electrons can very rapidly change state in the electrochemical processes (tunneling effect).

The increase in the active energy-storing materials increases the specific energy (energy density) in the accumulator. The total amount of active material is connected to the battery capacity (also called nominal capacity) and participates in the electrochemical reactions. The nominal capacity Cₙ and nominal voltage Uₙ (E=Cₙ*Uₙ) give the energy content (watts h=3.6 kJ) of the accumulator. If the cell is provided with a greater amount of active material and hence the amount of charge Q, battery capacity C and energy content E are increased, the Li ion accumulators can have a lighter and flatter design. For large amounts of energy-storing materials, there are commercial operators of ALD plants that are able to endow several tonnes per day of carrier material with the energy-storing and electrochemically active substances from the gas phase.

The coated carrier materials (conductive titania needles, graphite, CNTs, graphene nanoplatelets) can be used in the following electrodes:
electrodes for the electrolysis of water,
electrodes for the utilization of carbon dioxide, carbon dioxide electrolysis for production of synthetic fuel gases (CO₂ to value).

Conductive titania needles may be coated seamlessly by means of ALD methods with fast electron-conducting materials (for example atomic germanium layer) and with corresponding catalyst for the electrolysis, such that the active catalyst sites can more efficiently accelerate the electrochemical reactions through rapid electron transitions. The titania needles coated with energy-storing materials can be incorporated into polymeric materials (polyvinylidene fluoride PVDF or acrylonitrile-butadiene-styrene ABS) and processed further to give a plastic filament. This plastic filament can then be used in the FFF (fused filament fabrication) printing method for production of 3D accumulators.

Use of lithium ion accumulators having high energy density, capacity, energy content and power density in modern vehicle technology (car, aircraft) by distinct reduction in weight and hence a distinct increase in range. Since the new active materials combine both properties (high energy density and high power density), it is also possible to rapidly store the energies that result from mechanical processes (friction, braking). This also makes a contribution to reducing energy losses in modern vehicle technology.

The new active materials can also be used as stationary storage means in a power grid for stabilization in the event of power fluctuations, especially in the case of utilization of renewable energies from wind and sun. Another possibility is a 2nd life utilization of the new materials from spent aircraft and electrical vehicle batteries.

Further details are described hereinafter with reference to the drawings. Identical or corresponding drawing elements are each given the same reference numerals and are only elucidated repeatedly to the extent to which differences arise between the individual figures. The working examples elucidated hereinafter are merely some embodiments of the teachings herein. In the working examples, the components of the embodiments described each constitute individual features of the teachings that are to be considered independently of one another, each of which also constitute independent developments and hence should also be regarded as part of the scope of the teachings individually or in a combination other than that detailed. Furthermore, the embodiments described can also be supplemented by further features as described above.

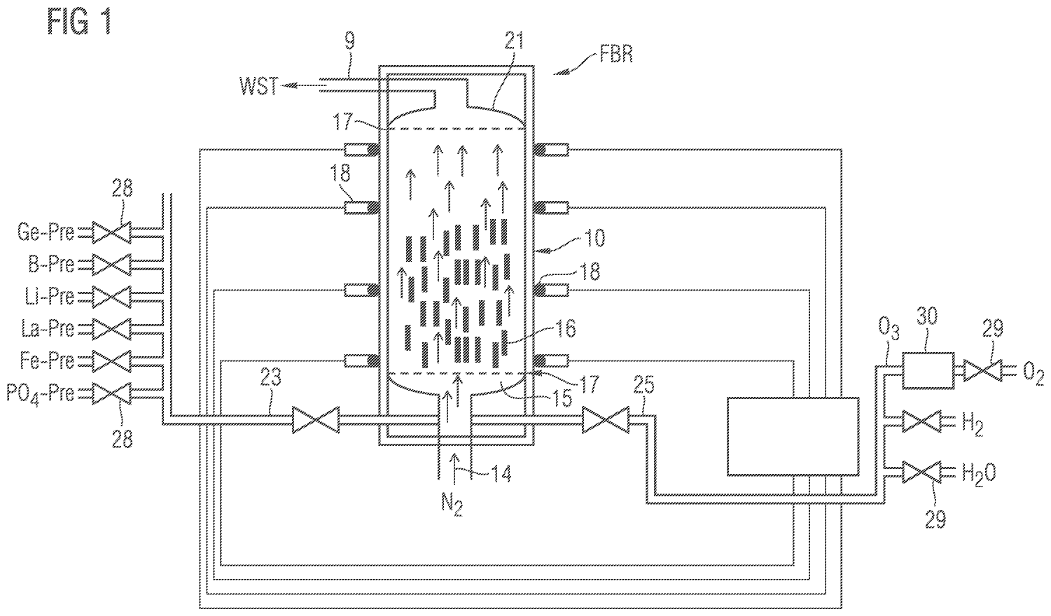

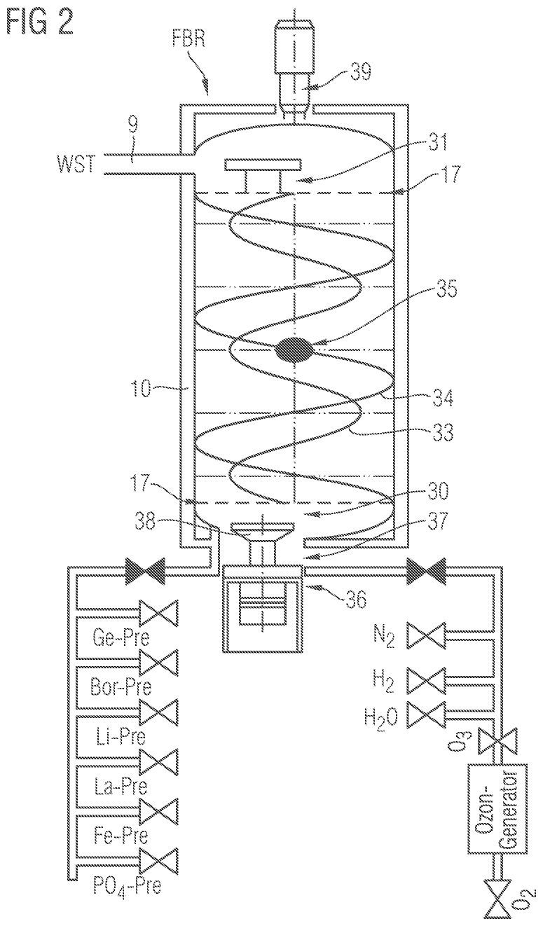

FIGS. 1 and 2 show fluidized bed reactors with which the nanoparticles, e.g. the titania needles or graphene flakes, can be coated by atomic layer deposition. It is possible here to very exactly control the thickness of the layers deposited, which means that it is possible to exactly adjust the electrical properties of the nanoparticles produced. There follows an elucidation of the procedure in the fluidized bed reactors with reference to examples.

### First Process Sequence:

The titania needles are introduced into a fluidized bed reactor (FBR). Such a fluidized bed reactor is shown in FIG. 1. The gas 14, which acts as a fluid, enters the reactor through a distributor 15 localized at the base of a vacuum chamber 21 of the reactor. The gas flows upward through the particle bed and as it does so exerts an upward force on the particles 16 (titania needles). The titania needles would otherwise be pulled downward under their own weight and gravity. The gas stream should be adjusted such that the forces acting in the upward and downward directions are balanced and the result is a fluidized state. In order that the titania needles are not sucked or blown out of the reactor, there is one particle filter 17 at the upper end and one at the lower end of the FBR. The carrier gas is discharged from the reactor through an outlet 9 for offgases WST. A heater 10 (not shown in detail) is provided in the wall.

To overcome the agglomeration forces between the needles, supporting methods are needed for establishment of a fluidized state. Vibration of the fluidized bed can be controlled and regulated by ultrasound sources 18 mounted on the outer wall of the FBR, and by means of an ultrasound generator 19. When the titania needles are in the reactor, a pump is used to establish a fine vacuum of 10⁻³ mbar in the reactor. This means that the air is pumped out. Thereafter, the needles are converted to a fluidized state by introduction of inert gas. In the fluidized state, the reactor space is heated to 140 to 230° C. via thermal radiation. For this purpose, there is a heating sleeve (not shown) outside the reactor. The precursors are stored in bubblers (not shown) to guard against atmospheric oxygen and air humidity and heated to 80 to 90° C. by means of a thermostat. The bubbler is equipped with a feed pipe and a withdrawal pipe. Carrier gas (nitrogen) enters the bubbler via the feed pipe and mixes with the precursors therein.

The electrically conductive titania needles are available from Ishihara in different ratios of length and width (FT1000; thickness: 0.13 μm, length: 1.68 μm, FT2000; thickness 0.21 μm, length: 2.86 μm, FT3000; thickness: 0.27 μm, length: 5.15 μm, specific resistivity: 10 to 60 ohm cm).

The nitrogen/precursor vapor mixture leaves the bubbler via the withdrawal pipe 23 and is guided pneumatically into the FBR via pipes with the aid of valves 28. The precursor stream in the FBR is monitored and controlled via the vapor pressure of the precursor and the regulated flow rate of the N2 carrier gas such that a monolayer of the precursor is chemisorbed on the surface of the titania needles.

In a second step, excess precursor gas molecules are removed and the FB reactor is purged with nitrogen. In the next step, the appropriate reactants (water, ozone or hydrogen) are introduced into the FBR. The reactants react immediately with the metal or phosphate precursors sorbed to form metal, metal oxide or metal phosphate and the volatile organic substituents. Subsequently, the volatile substituents and the excess reactants (water, ozone, hydrogen) are pumped out. Then the FBR space and the coated needles are purged with nitrogen.

### Second Process Sequence:

In order, for example, to keep graphene nanoplatelets and CNTs suspended counter to gravity, the ALD process is assisted by use of ultrasound waves (acoustic levitation). To implement this method, a fluidized bed reactor according to FIG. 2 is required (to the extent that it corresponds structurally to the construction of the reactor according to FIG. 1, the same reference numerals have been used; see description of FIG. 1). By means of this, the particles can move entirely freely through the space, and uniform coating of all particles is achieved.

The principle of acoustic levitation is the standing wave effect in an ultrasound field. An ultrasound source 30 stands opposite a reflector 31 at a distance L of a whole multiple of half the wavelength λ of the ultrasound:

L=nλ/2.

Under these conditions, the soundwave emitted is reflected onto itself, giving rise to a standing wave. This consists of alternating areas of high sound velocity 33 (nodes) and areas of high sound pressure 34 (antinodes). The particles 35 can be positioned without contact in the nodes of this wave.

Given appropriate strength of the ultrasound field, the gravity of the particles 35 is compensated for by the levitation force. The particles, by virtue of the flow mechanics effects of the high-frequency movement of gas, repeatedly return to the center of the node. The forces that keep the particles in the pressure nodes of the standing sound field are differentiated into axial and radial positioning forces. The axial positioning force acts parallel to the center axis of the field, the radial positioning force at right angles thereto.

The ultrasound source 30 may have, for example, a piezoelectric ceramic 36 that transmits the vibrations to a piston oscillator 38 via a sound absorber 37. This produces the standing waves in association with the reflector 31. In order to produce the standing wave, exact positioning of the reflector 31 with respect to the piston oscillator 38 is required. For this purpose, there is a micrometer screw 39 disposed in the reactor.

The two forces are in a ratio of about 5:1 to one another. Given suitable strength of the ultrasound field of a particle of appropriate dimensions, they can balance and prevent migration radially and axially away from the pressure nodes. At the site of the pressure nodes, there are potential wells in which the particles are positioned and levitated without contact. These pressure nodes result in positioning and levitation forces. The positioning of a particle depends on the density and size of the particle and on the energy density and frequency of the standing ultrasound wave, the speed of sound in the sample medium and in the surrounding carrier medium, and the dimensions of the acoustic resonator. The maximum sample size that can be positioned stably in an acoustic levitator depends on the frequency of the standing field.

FIG. 2 shows the schematic construction of a tubular reactor with an ultrasound levitator. In order to generate high sound intensities in the acoustic levitation, a piezoelectric transducer is used. Piezoelectric elements used are barium titanate or lead zirconium titanate. By applying external electrical fields to the piezoelectric ceramics, these are periodically deformed. These mechanical fluctuations in thickness must be transmitted to the carrier medium in the resonator of the ultrasound levitator, for example nitrogen, via a suitable mechanical construction (horn) for amplification and transformation of the amplitude.

At the opposite end of the reactor, above the ultrasound transducer, is mounted the reflector 31, in order to obtain a standing soundwave needed for the levitation of the particles. The soundwave emitted is reflected back into itself. Given a suitable distance between ultrasound transducer 30 and reflector 31, a standing ultrasound field is formed. Ultrasound transducer and reflector result in an acoustic resonator. The resonator length can be varied with the aid of a micrometer screw 39 on the reflector.

The customary working frequencies of ultrasound levitators are in the range from 20 to 100 kHz. The resonance frequencies have to be determined experimentally. Suitable induction electronics (not shown) are needed for the purpose of operating the acoustic trap (levitator). With the aid of a function generator, the acoustic trap can be induced to give sinusoidal vibrations of a fixed frequency. If the sine generator on its own is not suitable for supplying the acoustic trap with sufficient electrical power, a power booster appropriate to the trap is required as well. With the aid of an oscilloscope, it is possible to observe and measure the output voltage U₀ of the sine generator (corresponding to the input voltage of the booster) and the output voltage U_{A} or the output current I_{A} of the booster.

### Production of the Anode Material

For production of the anode material, the electrically conductive carrier material is deposited from the vapor phase with germanium, boron or boron oxide and lithium via metal precursors. The production steps for the individual species are illustrated hereinafter and by word equations.

### First Layer: Germanium

Germanium is in the fourth main group below silicon in the Periodic Table, is a semimetal and is counted among the semiconductors. Monotonic layers of germanium conduct electrons 10 times more quickly than silicon. For that reason, germanium is deposited atomically onto the electrically conductive carrier material via the ALD method in order that, on discharge of the cell, the electrons flow rapidly from the lithium atoms into the external circuit and, conversely, on charging, the electrons are accepted rapidly by the lithium ions from the external circuit. For germanium, it is possible to use the following precursors:

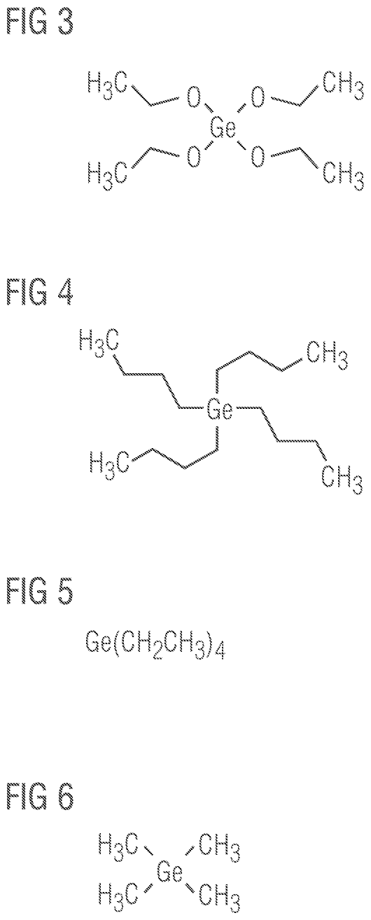

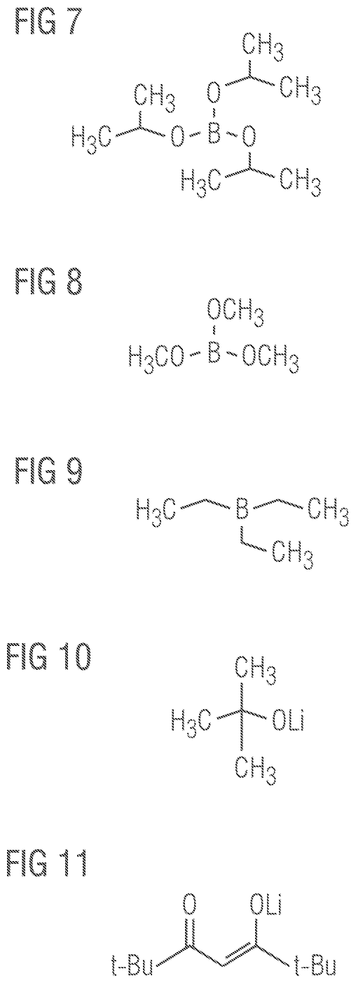

germanium(IV) ethoxide according to FIG. 3,
tetra-n-butylgermane according to FIG. 4,
tetraethylgermane according to FIG. 5,
tetramethylgermane according to FIG. 6.
Application Using the Example of tetra-n-butylgermane

Tetra-n-butylgermane has a boiling point of 130 to 133° C.

TiO₂ with Sb/SnO₂+tetra-n-butylgermane=TiO₂ with Sb/SnO₂ (equation 1)

Evacuating and Purging with Nitrogen to Remove Excess tetra-n-butylgermane

Introducing hydrogen: hydrogen is used as a second reactant to eliminate butane from the Ge precursor and obtain germanium in metal form.

TiO₂ with Sb/SnO₂+2H₂=TiO₂ with (Sb/SnO₂ and Ge)+4 n-butane (equation 2)

Evacuating and Purging with Nitrogen to Remove n-butane

### Second Layer: Boron or Boron Oxide

Boron is in the third main group, second period, in the Periodic Table and, owing to its 1s²2s²2p¹ electron configuration, is able to provide only the three electrons from the second shell for the formation of covalent bonds. This electron deficiency is compensated for by factors including electron acceptor behavior; boron therefore attracts the electrons from germanium and generates positive charges in the germanium. The formation of the positive sites in the germanium and the electron deficiency of the boron result in acceleration of the processes of oxidation and reduction of the lithium atoms in the course of charging and discharging at the anode. Boron can be deposited by means of the following precursors:

triisopropyl borate,
trimethyl borate,
triethylborane,
boron triboride,
boron trichloride.

### Application Using the Example of Triisopropyl Borate

Triisopropyl borate has a boiling point of 139 to 141° C. and is the least hazardous of the boron precursors.

TiO₂ with (Sb/SnO₂ and Ge)+triisopropyl borate=TiO₂ with (Sb/SnO₂ and Ge triisopropyl borate) (equation 3)

Evacuating and Purging with Nitrogen to Remove Excess Triisopropyl Borate

Introducing hydrogen or water vapor: the second reactant used is hydrogen to eliminate isopropanol from the boron precursor and to obtain boron in metal form.

3 TiO₂ with (Sb/SnO₂ and Ge)+3 H₂=3 TiO₂ with (Sb/SnO₂ and Ge and B)+3 isopropanol (equation 4)

When water vapor is used, boron oxide is formed and isopropanol is eliminated. Lithium ions can then bind to the boron oxide as lithium tetraborate and hence protect the anode from metallization with lithium.

3 TiO₂ with (Sb/SnO₂ and Ge)+3H₂O=3 TiO₂ with (Sb/SnO₂ and Ge and B oxide)+3 isopropanol (equation 5)

Evacuating and Purging with Nitrogen to Remove Isopropanol

### Third Layer: Lithium

Lithium is in the first main group, second period, and is a lightweight metal, has the lowest density of the solid elements, has a very low standard potential (the most negative standard potential of all elements), and forms monovalent ions that can diffuse rapidly. For the reasons given, lithium is of very good suitability as a carrier of chemical energy in rechargeable batteries. Useful lithium precursors include:

lithium tert-butoxide according to FIG. 10,
2,2,6,6-tetramethyl-3,5-heptanedionatolithium according to FIG. 11.

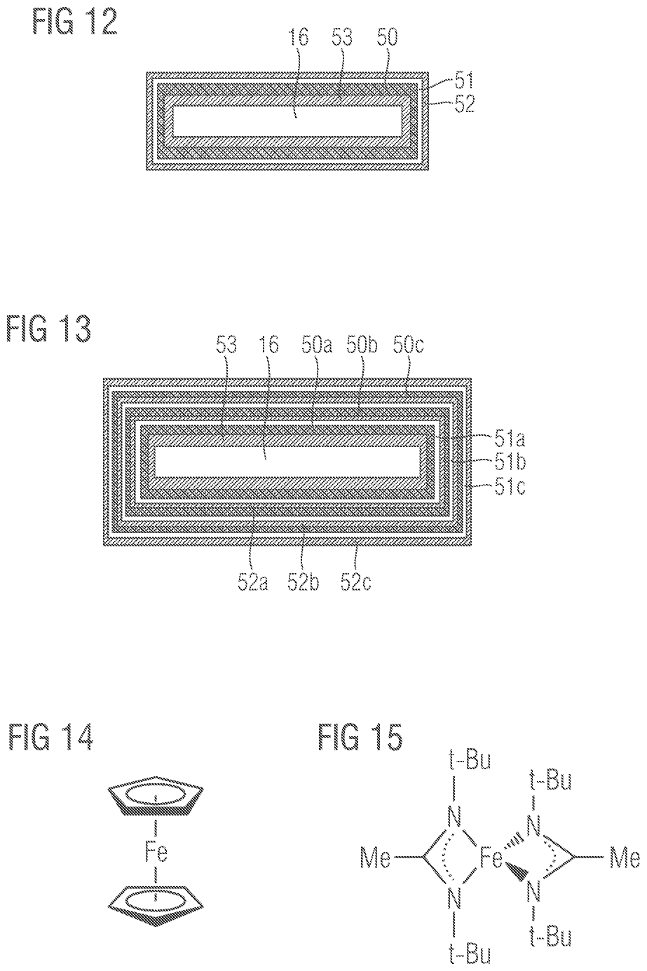

FIG. 12 shows a particle 16 in the form of a titania needle coated with four successive layers. As already mentioned, there is firstly a germanium layer 50 that has been produced in the manner described on the particle 16 (having an electrically conductive coating). This layer is followed by a second layer 51 of boron (or boron oxide) and a third layer 52 of lithium. This gives rise to a particle that can be used as anodic battery material.

FIG. 13 shows that the particle 16 can be constructed in the form of a titania needle with a multilayer structure of alternating layers as well. There has been alternate application of layers 50a to 50c of germanium, layers 51a to 51c of boron, and layers 52a to 52c of lithium on the particle. Since the particles 16 consist of titania and electrically conductive surface area on the particle is needed, an electrical conductive layer 53 has also been applied to the surface of the particles 16 according to FIG. 12 and FIG. 13. This may consist, for example, of SB or SnO₂.

Application of 2,2,6,6-tetramethyl-3,5-heptanedionatolithium

A working example selected is: 2,2,6,6-tetramethyl-3,5-heptanedionatolithium. This Li precursor has a boiling point of 180° C. and is the least hazardous of the Li precursors.

TiO₂ with (Sb/SnO₂ and Ge and B oxide)+2,2,6,6-tetramethyl-3,5-heptanedionatolithium=TiO₂ with (Sb/SnO₂ and Ge and B oxide and 2,2,6,6-tetramethyl-3,5-heptanedionatolithium) (equation 6)

Evacuating and Purging with Nitrogen to Remove Excess 2,2,6,6-tetramethyl-3,5-heptanedionatolithium

### Introducing Hydrogen

A second reactant used is hydrogen in order to eliminate the organic portion of the compound and to obtain metallic lithium on the carrier surface.

2 TiO₂ with (Sb/SnO₂ and Ge and B oxide)+H₂=2 TiO₂ with (Sb/SnO₂ and Ge and B oxide and Li)+2 2,2,6,6-tetramethyl-3,5-heptanedione (equation 7)

Evacuating and Purging with nitrogen to remove the diketone.

### Production of the Cathode Material

For a rechargeable battery, lithium metal oxide or lithium metal phosphate is required as cathode material. With regard to the risk of explosion that can emanate from lithium metal oxide-containing cathodes on charging as a result of self-heating of the cell (thermal runaway), preference is given to selecting the lithium metal phosphates. The lithium metal phosphates include lithium iron phosphate, lithium manganese phosphate, lithium cobalt phosphate and lithium nickel phosphate. Owing to the low proportion by mass and low raw material costs, we especially choose the deposition of lithium iron phosphate or lithium manganese phosphate onto an electrically conductive carrier via atomic layer deposition from the gas phase. Iron and manganese are lighter, are more common in nature and hence are cheaper than cobalt and nickel. The following procedure is applicable to the process steps:

### First Step: Iron

The following precursors for iron may be used:

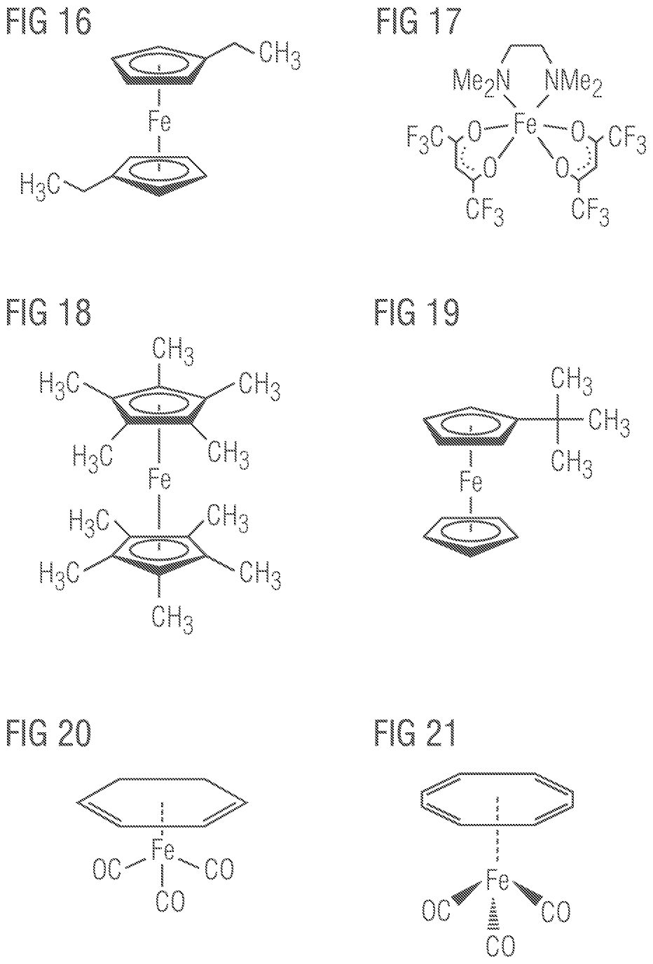

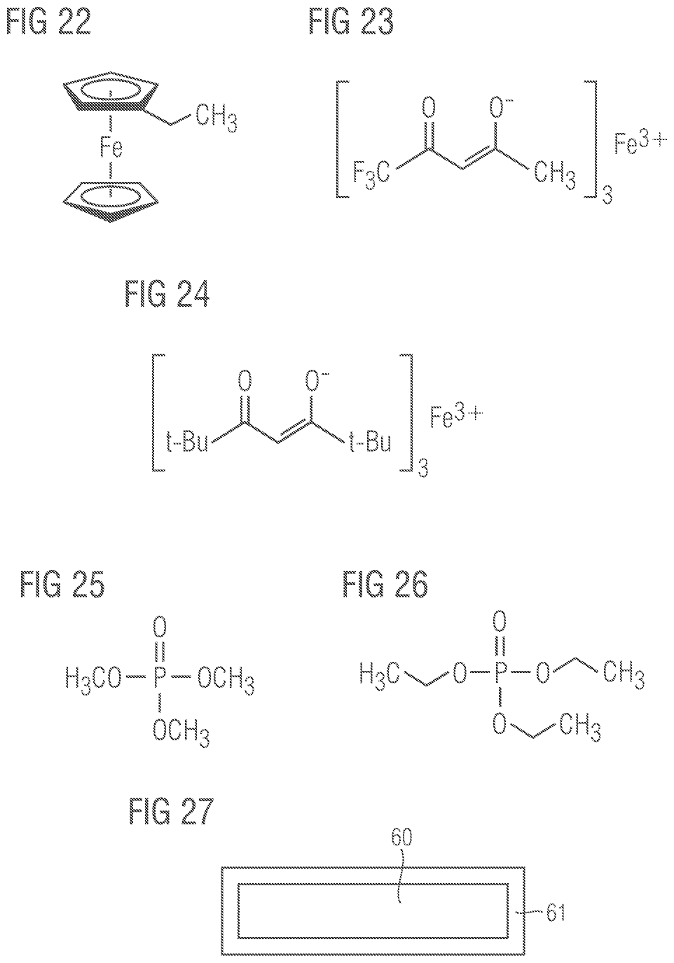

bis(cyclopentadienyl)iron according to FIG. 14,
bis(N,N′-di-t-butylacetamidinato)iron(II) according to FIG. 15,
bis(ethylcyclopentadienyl)iron according to FIG. 16,
bis(1,1,1,5,5,5-hexafluoroacetylacetonato) (N,N,N′,N′-tetramethylethylenediamine)iron(II) according to FIG. 17,
bis(pentamethylcyclopentadienyl)iron according to FIG. 18,
bis(i-propylcyclopentadienyl)iron,
tert-butylferrocene according to FIG. 19,
(cyclohexadiene)iron tricarbonyl according to FIG. 20,
cyclooctatetraene iron tricarbonyl according to FIG. 21,
ethylferrocene according to FIG. 22,
iron pentacarbonyl,
iron(III) trifluoroacetylacetonate according to FIG. 23,
tris(2,2,6,6-tetramethyl-3,5-heptanedionato)iron(III) according to FIG. 24.
Application of bis(cyclopentadienyl)iron

TiO₂ with Sb/SnO₂+bis(cyclopentadienyl)iron=TiO₂ with (Sb/SnO₂ and bis(cyclopentadienyl)iron)

Evacuating and purging with nitrogen to remove excess bis(cyclopentadienyl) iron.

### Introducing Ozone

Reacting bis(cyclopentadienyl)iron with ozone in order to produce iron oxide with a free oxygen radical-terminated surface and to remove cyclopentadiene, the organic substituent.

TiO₂ with (Sb/SnO₂ and bis(cyclopentadienyl)iron)+O₃=TiO₂ with (Sb/SnO₂ and FeO₃)+2 cyclopentadienyl (equation 8)

Evacuating and Purging with Nitrogen to Remove Excess Ozone and Cyclopentadiene

### Second Step: Preparation of the Phosphates

For deposition of phosphate, phosphoric esters are used as precursors, especially

trimethyl phosphate according to FIG. 25,
triethyl phosphate according to FIG. 26,
phosphorus(V) oxychloride (POCl₃)

### Introduction of the Phosphoric Ester, Trimethyl Phosphate TMPO

TiO₂ with (Sb/SnO₂ FeO₃+TMPO)=TiO₂ with (Sb/SnO₂ and FeO₃−TMPO) (equation 9)

Evacuating and Purging with Nitrogen to Remove Excess TMPO

### Introducing Water and Ozone

### Forming Iron Phosphate

2FeO₃+2 trimethyl phosphate+3 H₂O+O₃=2FePO₄+6CH₃OH 30 30₂ (equation 10)

Evacuating and Purging with Nitrogen to Remove Methanol and Oxygen

### Third Step: Lithium

Applying 2,2,6,6-tetramethyl-3,5-heptanedionatolithium.

TiO₂ with (Sb/SnO₂ AND FePO₄)+2,2,6,6-tetramethyl-3,5-heptanedionatolithium=TiO₂ with (Sb/SnO₂ FePO₄ and 2,2,6,6-tetramethyl-3,5-heptanedionatolithium) (equation 11)

Evacuating and Purging with Nitrogen to Remove Excess 2,2,6,6-tetramethyl-3, 5-heptanedionatolithium

### Introducing Hydrogen

A second reactant used is hydrogen to eliminate the organic portion of the compound and to obtain metallic lithium on the carrier surface.

2 TiO₂ with (Sb/SnO₂ and FePO₄ and 2,2,6,6-tetramethyl-3,5-heptanedionatolithium)+H₂=2 TiO₂ with (Sb/SnO₂ and FePO₄ and Li)+2 2,2,6,6-tetramethyl-3,5-heptanedione (equation 12)

Evacuating and Purging with Nitrogen to Remove the Diketone

The deposition and purging/evacuation processes described between the layer-producing cycles form a deposition cycle that can be repeated several times until the desired layer thickness of the LiFePO₄ has been attained.

The adsorption time for the precursors of iron, phosphate and lithium and for the reaction gases ozone, water vapor and hydrogen, the cleavage time to iron phosphate and to the breakdown products of the organic ligands, and the purge times between the layer-forming operations are within the order of magnitude of seconds. FIG. 27 shows a conductive TiO₂ needle 60 as particle (cf. 16 in FIG. 1) with a deposited LiFePO₄ layer 61.

### Lithium Manganese Phosphate

Rather than lithium iron phosphate, the cathode material used may also be lithium manganese phosphate, and may be deposited onto the conductive carrier materials mentioned. The carrier material is coated in a corresponding manner to the deposition of lithium iron phosphate in the aforementioned steps. Rather than the iron precursors mentioned, it is possible to use the following manganese precursors:

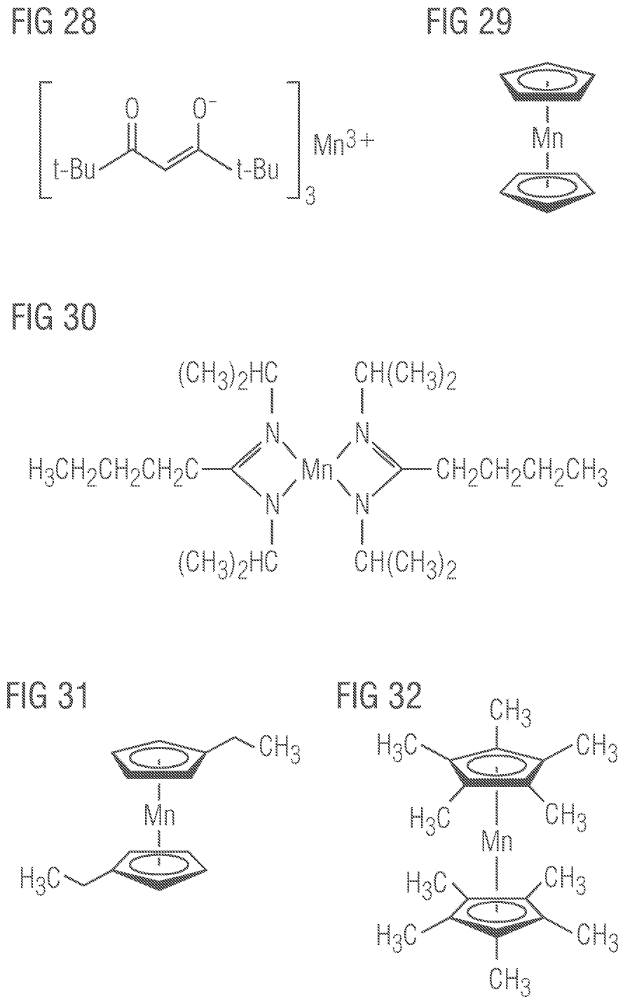

tris(2,2,6,6-tetramethyl-3,5-heptanedionato)manganese(III) according to FIG. 28,
bis(cyclopentadienyl)manganese(II)according to FIG. 29,
bis(N,N′-di-i-propylpentylamidinatomanganese(II) according to FIG. 30,
bis(ethylcyclopentadienyl)manganese(II) according to FIG. 31,
bis(pentamethylcyclopentadienyl)manganese(II) according to FIG. 32.

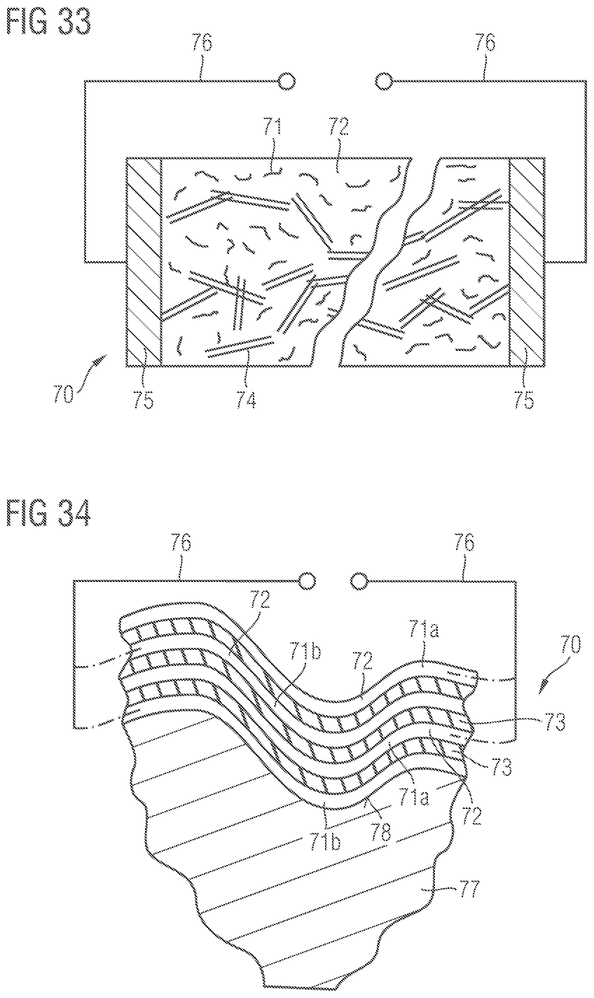

FIGS. 33 and 34 show examples of inventive lithium ion accumulators 70. These each include the inventive material 71, 71a, 71b, which, according to FIG. 33 is embedded as a mixture in a matrix 72 of polymer material and, according to FIG. 34, forms an anodic material 71a and a cathodic material 71b, where the materials 71a, 71b are separated in each case by interlayers 72. Materials 71a, 71b are each bound within a matrix 72.

Also distributed in the matrix 72 according to FIG. 33 are additional particles 74 that are electrically conductive. These further particles 74 have a concentration above the percolation threshold, such that an electrically conductive network is formed in the matrix 72 and forms an electrical connection between electrode layers 75. The electrode layers 75 may be connected to electrical terminals 76 that can be utilized as battery poles.

The accumulator according to FIG. 34 also has the terminals 76. These are connected alternately to the layers modified with the anodic particles 71a and with the cathodic particles 71b. The connection is merely indicated by a line of dots and dashes. The accumulator 70 according to FIG. 34 is also present on a component 77 shown merely as a cutout. It becomes clear that the accumulator follows an outline 78 of this component 77. The accumulator 70 can, for example, be applied to the outline 78 of the component 77 in a manner not shown by filament fusion fabrication (FFF).

### LIST OF REFERENCE NUMERALS

16 particle
50 germanium layer
51 second layer of boron
52 third layer of lithium
53 electrical conductive layer
70 lithium ion accumulators
71 material
71a anodic material
71b cathodic material
72 matrix
74 additional particles
75 electrode layers
76 electrical terminals
77 component
78 outline

1. A material for a lithium ion accumulator, the material comprising:
a surface including electrically conductive particles coated with a functional layer providing a cathodic or anodic function for the lithium ion accumulator;
wherein the conductive particles comprise microparticles and/or nanoparticles.

2. The material as claimed in claim 1, wherein the conductive particles comprise at least one substance selected from the group consisting of: graphite, titania with an electrically conductive coating, carbon nanotubes, and graphene nanoplatelets.

3. The material as claimed in claim 1, wherein the conductive particles comprise at least one shape selected from the group consisting of: needles, flakes, and platelets.

4. The material as claimed in claim 1, wherein the functional layer has a thickness less than 500 nm., preferably the thickness of one layer of atoms.

5. The material as claimed in claim 1, wherein:
the conductive particles provide an anode for the lithium ion accumulator; and
the anode comprises multiple layers in the following sequence from the inside out, consisting of:
germanium, boron or boron oxide, and lithium.

6. The material as claimed in claim 1, wherein:
the conductive particles provide a cathode for the lithium ion accumulator; and
the cathode comprises a lithium metal oxide and/or a lithium metal phosphate.

7. A lithium ion accumulator comprising:
an anode; and
a cathode;
wherein the anode comprises multiple layers in the following sequence from the inside out, consisting of:
germanium, boron or boron oxide, and lithium; and
the cathode comprises a lithium metal oxide and/or a lithium metal phosphate.

8. The lithium ion accumulator as claimed in claim 7, wherein:
the anode material and the cathode material are respectively mixed in a matrix comprising a plastic; and
the plastic comprises polyvinylidene fluoride and/or acrylonitrile-butadiene-styrene.

9. The lithium ion accumulator as claimed in claim 8, further comprising electrically conductive particles incorporated in the matrix.

10. The lithium ion accumulator as claimed in claim 7, wherein the anode material and the cathode material form separate layers separated from one another by an interlayer serving as an electrolyte.

11. The lithium ion accumulator as claimed in claim 10, further comprising particles incorporated in the anode material and/or in the cathode material.

12. A process for producing a lithium ion accumulator, the method comprising:
fabricating an anode with multiple layers in the following sequence from the inside out, consisting of:
germanium, boron or boron oxide, and lithium; and
fabricating a cathode comprising a lithium metal oxide and/or a lithium metal phosphate.

13. The process as claimed in claim 12, further comprising introducing the anode material and/or the cathode material in mixed form into a matrix comprising at least one plastic selected from the group consisting of: polyvinylidene fluoride and acrylonitrile-butadiene-styrene.

14. The process as claimed in claim 13, further comprising processing the anode material and/or the cathode material using fused filament fabrication.

15. The process as claimed in claim 12, wherein the process is conducted in a fluidized bed reactor.

16. The material as claimed in claim 1, wherein the functional layer has a thickness of one layer of atoms.
